(19) United States
(12) Patent Application Publication
(10) Pub. No.: US 2015/0070283 A1
(43) Pub. Date: Mar. 12, 2015

(54) TECHNIQUES FOR PROVIDING A SCROLLING CAROUSEL

(71) Applicant: Linkedln Corporation, Mountain View, CA (US)

(72) Inventor: Conrad Irwin, Mountain View, CA (US)

(73) Assignee: Linkedln Corporation, Mountain View, CA (US)

(21) Appl. No.: 14/019,842

(22) Filed: Sep. 6, 2013

(51) Int. Cl. G09G 5/00; G06F 3/041; G06F 3/0485

(52) U.S. Cl. CPC G09G 5/006; G06F 3/0485; G06F 3/0416
USPC 345/173

(57) ABSTRACT

Techniques of providing a scrolling carousel are disclosed. Visual content of a carousel may be displayed on a touch screen. The visual content may be configured to be scrolled through via user-directed movement across the touch screen. Information about a user-directed movement across the touch screen may be received. A velocity of the user-directed movement may be determined based on the received information. An intention for movement of visual content of the carousel may be determined based on the determined velocity. A stopping position for the movement of the visual content may be determined based on the determined intention. A B-spline curve function may be used to determine an animation of the movement of the visual content to the stopping position. The determined animation of the movement of the visual content to the stopping position may be caused to be displayed on the touch screen.

### TECHNICAL FIELD

The present application relates generally to the technical field of data processing, and, in various embodiments, to systems and methods of providing a scrolling carousel.

### BACKGROUND

Touch screen devices allow users to move visual content displayed on a touch screen via user-directed movements, such as swiping the touch screen with a finger. However, a problem arises in getting the behavior of the visual content right when the user lifts his or her finger from the screen. For example, when a user swipes the touch screen in order to browse through content of a scrolling carousel, a discontinuity in the animation of the moving content may occur when the user's finger leaves the screen at the end of the swiping motion. Before the point of the user's finger lifting up away from the screen, the position of the visual content on the screen can be set manually by JavaScript in response to a jQuery touchmove event. However, after the point of the user's finger lifting up away from the screen, it is necessary to guess at what the user expects and to continue the animation of the visual content in a way that is consistent with this expectation. Such a task can be difficult, especially when the animation is being used for the content of web applications. Web applications are at a disadvantage in this regard, as they run in the context of a web browser, thereby letting the software do most of the rendering, in contrast to native applications that can access the touch screen device's graphical processing unit to perform the animation.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system, within which various example embodiments may be deployed, in accordance with some embodiments;

FIGS. 2A-2E illustrate a use of a scrolling carousel system on a touch screen device, in accordance with some embodiments;

FIG. 3A illustrates a graph depicting a discontinuity in the animation of visual content on a touch screen device, in accordance with some embodiments;

FIG. 3B illustrates a graph depicting continuity in the animation of visual content on a touch screen device, in accordance with some embodiments;

FIG. 4 is a block diagram illustrating a scrolling carousel system, in accordance with some embodiments;

FIG. 5 is a flowchart illustrating a method of providing a scrolling carousel, in accordance with some embodiments;

FIG. 6 is a flowchart illustrating a method of using a B-spline curve to determine an animation of movement of visual content on a touch screen, in accordance with some embodiments; and

FIG. 7 shows a diagrammatic representation of a machine in the example form of a computer system within which a set of instructions may be executed to cause the machine to perform any one or more of the methodologies discussed herein, in accordance with some embodiments.

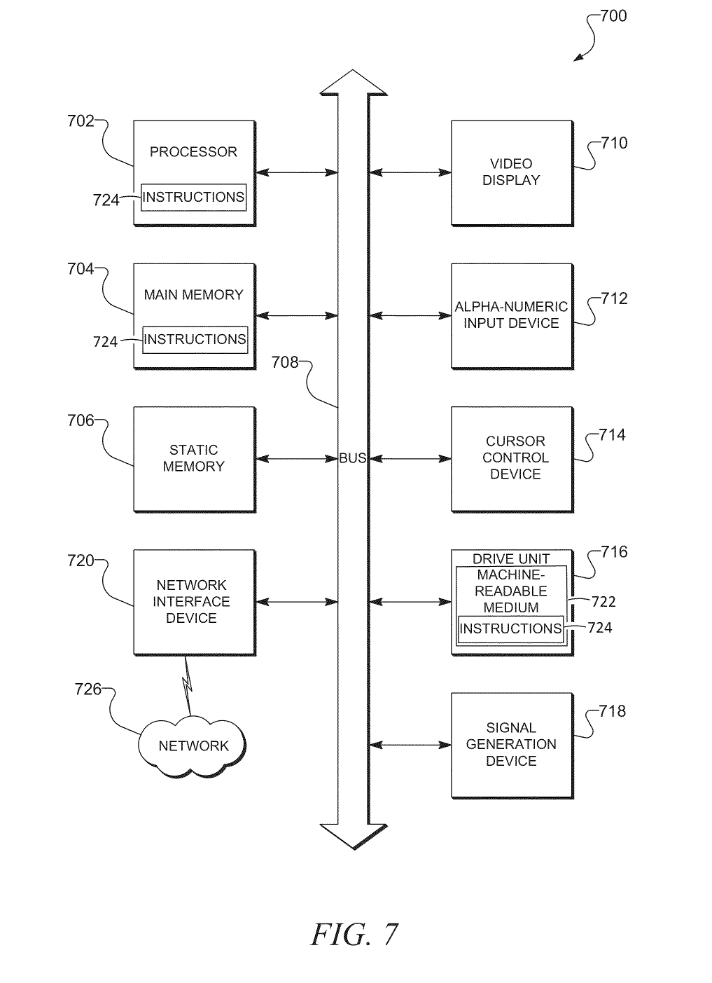

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes techniques for providing a scrolling carousel. A B-spline curve (e.g., a Bèzier curve) may be used to determine an animation of the movement of visual content being displayed on a touch screen when a user-directed movement is being used to move the visual content.

In some embodiments, a method may comprise causing visual content of a carousel to be displayed on a touch screen. The visual content of the carousel may be configured to be scrolled through via user-directed movement across the touch screen. Information about a user-directed movement across the touch screen may be received. A velocity of the user-directed movement across the touch screen may be determined based on the received information. An intention for movement of visual content of the carousel may be determined based on the determined velocity. A stopping position for the movement of the visual content of the carousel may be determined based on the determined intention. A B-spline curve function may be used to determine an animation of the movement of the visual content to the stopping position. The determined animation of the movement of the visual content to the stopping position may be caused to be displayed on the touch screen. In some embodiments, the B-spline curve function is a Bèzier curve function. In some embodiments, the user-directed movement comprises a finger of the user moving across and in direct contact with the touch screen. In some embodiments, the touch screen is disposed on a mobile device. In some embodiments, the visual content of the carousel comprises web-based content.

In some embodiments, the information about the user-directed movement across the touch screen comprises a distance measurement and a time measurement. The distance measurement may comprise a distance between a first position of user-directed contact with the touch screen during the user-directed movement across the touch screen and a second position of user-directed contact with the touch screen during the user-directed movement across the touch screen. The first position may be a second-to-last detected position of user-directed contact with the touch screen during the user-directed movement. The second position may be a last-detected position of user-directed contact with the touch screen during the user-directed movement. The time measurement may comprise an amount of time between the user-directed contact at the first position and the user-directed contact at the second position. A velocity of the user-directed movement across the touch screen may be determined by dividing the distance measurement by the time measurement. In some embodiments, using the B-spline curve function to determine the animation comprises mapping the second position and the stopping position in a Cartesian coordinate system having a position axis and a time axis. The position axis may correspond to positions on the touch screen. A B-spline curve may be interpolated between the second position and the stopping position in the Cartesian coordinate system. The animation of the movement of the visual content to the stopping position may be determined based on the interpolation of the B-spline curve between the second position and the stopping position. In some embodiments, the determination of the intention for movement of visual content of the carousel is further based on the second position of user-directed contact with the touch screen during the user-directed movement across the touch screen.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

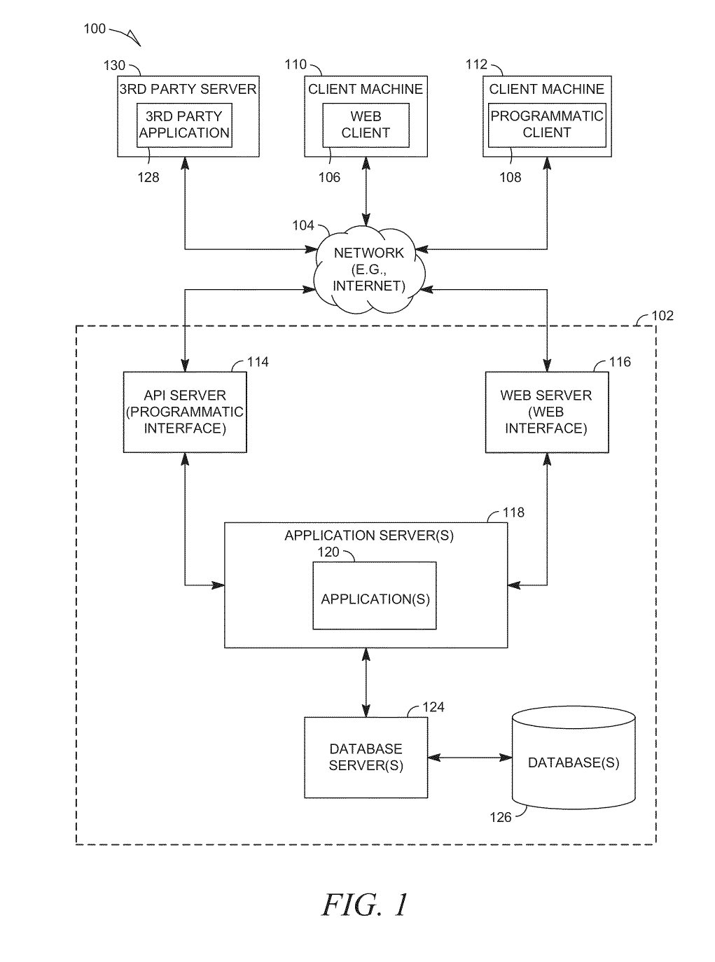

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

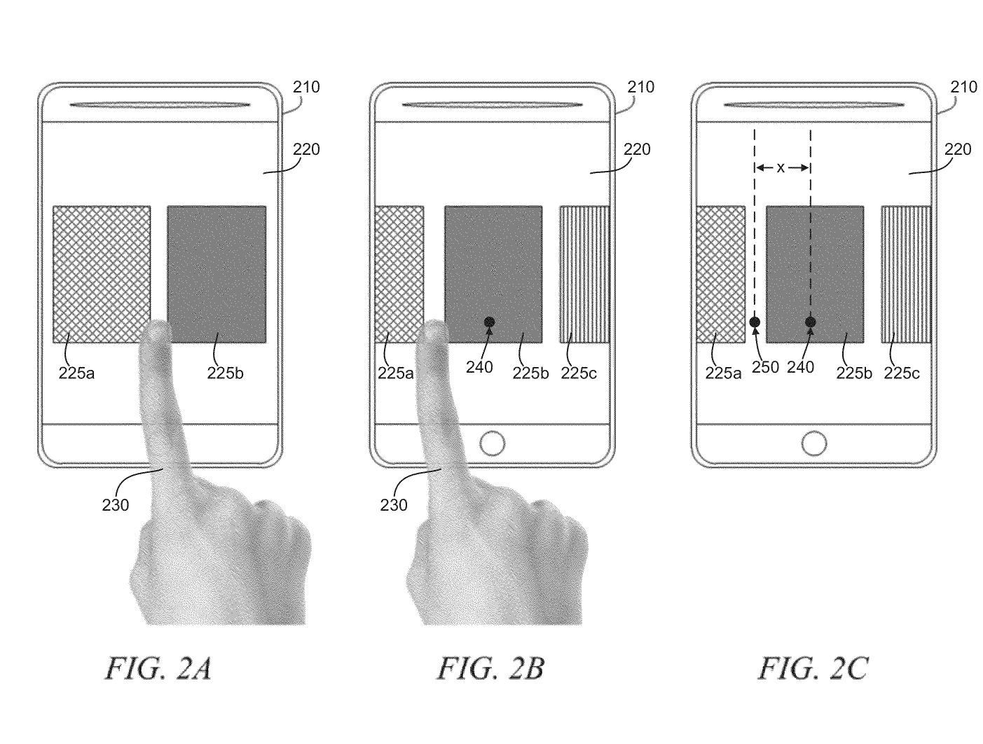

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may correspond to one or more of the modules of the system 210 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

FIGS. 2A-2E illustrate a use of a scrolling carousel system on a touch screen device 210, in accordance with some embodiments. In some embodiments, the touch screen device 210 may be one of the machines 110, 112, or 130 in FIG. 1. In some embodiments, the touch screen device 210 may be a mobile device. The mobile device may be a smartphone or a tablet computer. Other types of mobile devices are also within the scope of the present disclosure. Additionally, the touch screen device 210 may be a non-mobile device. The touch screen device 210 comprises a touch screen 220 that provides an electronic visual display of visual content that the user can control using simple or multi-touch gestures by touching the screen with one or more fingers 230. The user can provide user-directed movement with his or her finger(s) 230. In some embodiments, the user may also provide user-directed movement via an object (e.g., a stylus).

In some embodiments, visual content of a carousel may be displayed on the touch screen 220. The visual content may be divided into distinct items. For example, the visual content may comprise a plurality of distinct slides, pages, or images. It is contemplated that other forms of visual content items are within the scope of the present disclosure. In some embodiments, the carousel may comprise a large number of visual content items, but only a small portion of those visual content items may be displayed on the touch screen 220 at the same time. The carousel may be configured to enable the user to scroll through its visual content items via user-directed movement across the touch screen 220. The user can browse through all of the visual content items of the carousel, moving back and forth.

In the example shown in FIG. 2A, visual content items 225a and 225b of a carousel are displayed on the touch screen 220. The user may want to see other visual content items of the carousel. The user may use his or her finger 230 to provide a user-directed movement to scroll through the visual content items of the carousel. For example, the user may touch the touch screen 220 with his or her finger 230, and then swipe the screen in a leftward direction in order to bring other visual content items into display on the touch screen 220.

In the example shown in FIG. 2B, the user has swiped the touch screen 230 in a leftward motion, thereby moving visual content item 225a of the carousel leftward and partially off-screen, moving visual content item 225b of the carousel leftward and to the center of the touch screen 220, and bringing visual content item 225c partially on-screen from the right. FIG. 2B shows the beginning point 240 of the user's swiping motion.

In the example shown in FIG. 2C, the user's swiping motion has been completed, and the user's finger 230 has been removed from contact with the touch screen 220. FIG. 2C shows the departure point 250 of the user's finger 230 from the touch screen 220 at the termination of the swiping motion, as well as the distance x between the beginning point 240 and the departure point 250.

The movement of the visual content of the carousel after the user's finger 230 has left the touch screen 220 may be determined based on a determination of the user's intent. For example, if it is determined that the user intended to scroll through several of the visual content items, then the visual content items may be moved accordingly on the touch screen 220 (e.g., visual content items 225a and 225b may be shifted completely off-screen, and visual content items several positions down on the carousel may be brought on-screen).

In another example, if it is determined that the user did not intend to scroll to any other visual content items in the carousel, then the visual content items that were displayed on-screen at the beginning of the user-directed movement may spring back into the same positions they were at wen the user-directed movement began. For example, in FIG. 2E, it may have been determined that the user did not intend to scroll to any other visual content items in the carousel, thus resulting in visual content items 225a and 225b returning to the same positions they had in FIG. 2A, before the swiping motion began.

In yet another example, if it is determined that the user intended to scroll to the next visual content item in the carousel, then the next visual content item may be shifted into display on-screen from one side of the touch screen 220, while one of the visual content items at the other end of the touch screen 220 may be shifted off-screen. For example, in FIG. 2E, it may have been determined that the user intended to scroll to the next visual content item in the carousel, thus resulting in visual content item 225a being shifted off-screen and visual content item 225c being shifted on-screen.

The user's intention for the movement of the visual content may be determined based on characteristics of the user-directed movement. Such characteristics may include, but are not limited to, the velocity of the user-directed movement (e.g., the velocity of the swiping motion) and the positioning of the user directed movement. Other characteristics are also within the scope of the present disclosure. In some embodiments, certain thresholds for these characteristics may be stored and used to determine the user's intention for the movement of the visual content. For example, scrolling to the next visual content item may be conditioned on the user-directed movement having a velocity of at least X, while, scrolling to the next two visual content items may be conditioned on the user-directed movement having a velocity of at least Y, and so on and so forth. In some embodiments, correlations between the characteristics and user intentions for movement of visual content may be stored and used to determine the user's intention for the movement of the visual content. For example, a velocity between 0 and X may be correlated with a user's intention to not scroll to any other visual content items, while a velocity between X and Y may be correlated with a user's intention to scroll to the next visual content item, and so on and so forth.

A use a Cascading Style Sheets (CSS) transition or animation may be used to determine and carry out the movement of the visual content expected by the user. However, there is one main issue with using CSS transitions after the user has completed the user-directed movement, such as after the user's finger has been removed from contact with the touch screen): unless the transition is chosen carefully, there will be an unpleasant bump at the point that the finger leaves the screen. The reason for this effect is that the user is moving the visual content at a particular velocity in order to drag it out of the way, and the browser's CSS engine is also moving the slide at a velocity defined by the choice of Bèzier curve. Unless these two velocities match exactly, the user will experience a C(1) discontinuity, which is subliminally distressing to the user.

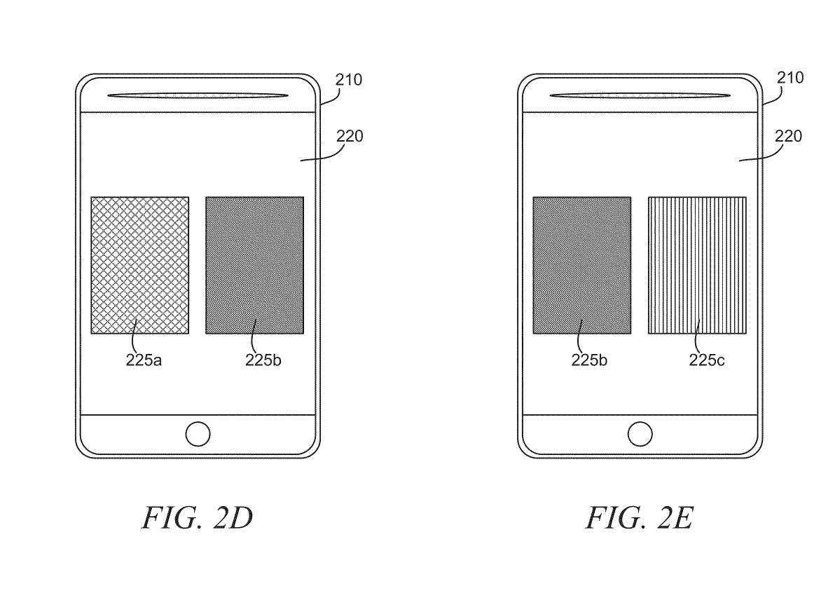

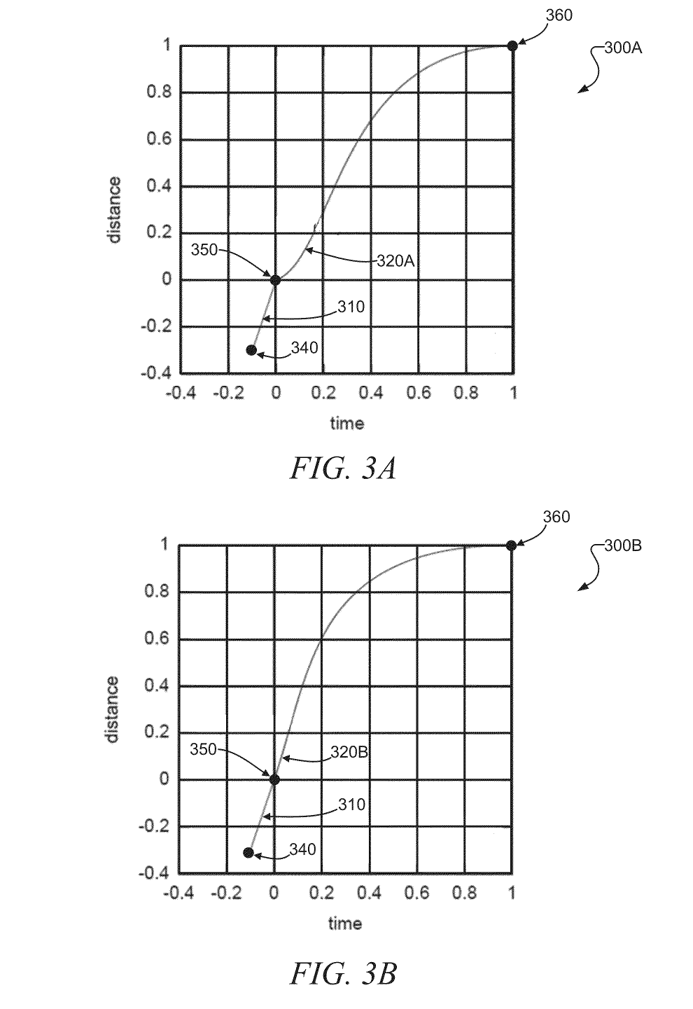

FIG. 3A illustrates a graph 300A depicting a discontinuity in the animation of visual content on a touch screen device, in accordance with some embodiments. Graph 300A shows a representation of the movement of visual content on the touch screen by mapping the distance of the movement against the change in time. This movement is represented by a line comprising a beginning portion 310, defined by the user-directed movement from a beginning point 340 to a departure point 350, and an ending portion 320A, defined by an estimated expectation of what the user intended for the movement of the visual content from departure point 350 to a stopping point 360. In some embodiments, the beginning point 340 may correspond to the beginning point 240 in FIGS. 2B-2C, the departure point 350 may correspond to the departure point 250 in FIG. 2C, and the distance between the beginning point 340 and the departure point 350 may correspond to distance x in FIG. 2C. Accordingly, the ending portion 320A corresponds to the time after the user-directed movement has ended (e.g., after the user's finger has been removed from contact with the touch screen at the end of the swiping motion).

CSS easing may be used to determine the ending portion 320A. However, as previously discussed, a discontinuity may arise between the beginning portion 310 and the ending portion 320A, such that the movement of the visual content after the user-directed movement has ended is not consistent with the movement of the visual content before the user-directed movement has ended. As a result of this lack of a smooth transition between the beginning portion 310 and the ending portion 320A, the animation of the movement of the visual content may be subtly distressing to the user.

Fortunately, the way that B-spline curves, and particularly Bèzier curves, are constructed makes it possible to avoid this case of discontinuity. In some embodiments, the velocity of a transition is proportional to the gradient of the B-spline curve, and the gradient at the start of the curve cubic-bezier (a, b, c, d) is a/b. Therefore, in order to provide a smooth transition, the velocity at which the user is moving the visual content may be measured, and a/b may be set equal to that velocity measurement, which may correspond to the user velocity between beginning point 340 and departure point 350.

In order to make the animation of the visual content stop smoothly, parameter d may be set to equal 1, thereby making the final velocity hit 0 at the same time as the animation stops. Other constraints on the curve may be used as well.

FIG. 3B illustrates a graph 300B depicting continuity in the animation of visual content on a touch screen device, in accordance with some embodiments. Graph 300B is the same as graph 300A, except that ending portion 320A has been replaced with ending portion 320B as a result of the use of a calculated Bèzier curve being used to form this portion between departure point 350 and stopping point 360. Stopping point 360 may represent parameter d of the Bèzier curve and be set to 1 as discussed above. The Bèzier curve, or another B-spline curve, may be interpolated between the departure point 350 and the stopping point 360. As seen in FIG. 3B, the result of this interpolation of the Bèzier curve may result in a much smoother transition than in FIG. 3A.

The use of a B-spline curve may also be useful in simulating the effect of bouncing. For example, if the user flicks over the end of a set of slides, or other visual content, of the carousel, the animation should continue moving in the direction of the flick for a short time before decelerating and then reversing back into place. Likewise, in another example, if the user moves towards the edge of a slide with high velocity (though not quite enough to jump them to the next slide), the slide should appear to animate just beyond the end and then return back, appearing to bounce back in place to where it was just before the flick.

In some embodiments, the beginning point 340 may not correspond to the point where the user-directed movement began, and the departure point 350 may not correspond exactly to the departure point 250 of the user's finger 230 from the touch screen 220 at the termination of the user-directed movement. In some embodiments, the positioning of the user-directed movement (e.g., the position of the user's finger) may be detected periodically at regular intervals. The beginning point 340 and the departure point 350 may correspond to the last two detected positions of the user-directed movement (e.g., the last two detected positions of the user's finger contacting the touch screen). The velocity of the user-directed movement may then be calculated using these last two detected positions and the time between them.

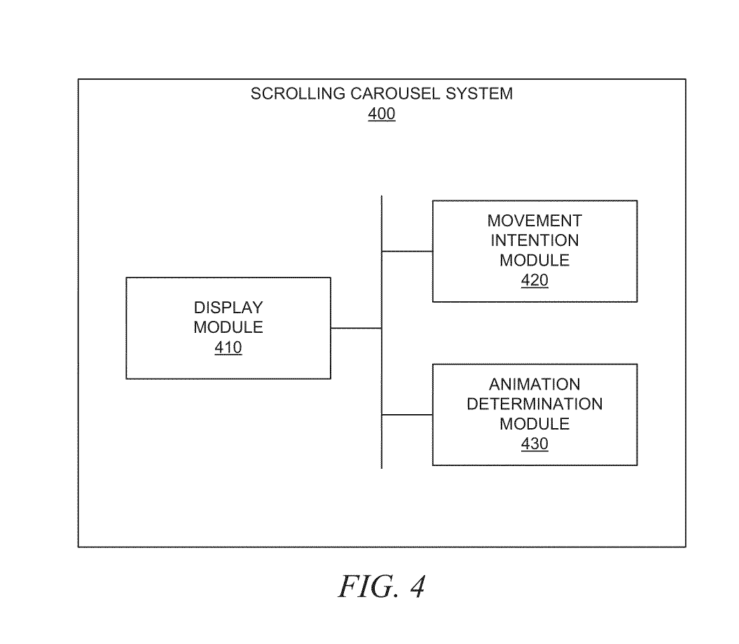

FIG. 4 is a block diagram illustrating a scrolling carousel system 400, in accordance with some embodiments. The scrolling carousel system 400 may comprise a machine having a memory and at least one processor (not shown) for executing one or more modules. In some embodiments, some or all of the components of the scrolling carousel system 400 may reside on the application server(s) 118 in FIG. 1. In some embodiments, some or all of the components of the scrolling carousel system 400 may reside on a touch screen device, such as touch screen device 210 in FIGS. 2A-2E. In some embodiments, the scrolling carousel system 400 may comprise a display module 410, a movement intention module 420, and an animation determination module 430.

In some embodiment, the display module 430 is configured to cause visual content of a carousel to be displayed on a touch screen. The visual content of the carousel is configured to be scrolled through via user-directed movement across the touch screen. The visual content of the carousel may comprise web-based content (e.g., the content of a website). Other types of visual content are also within the scope of the present disclosure.

In some embodiments, the movement intention module 420 is configured to receive information about a user-directed movement across the touch screen, and then determine a velocity of the user-directed movement across the touch screen based on the received information. The movement intention module 420 may then determine an intention for movement of visual content of the carousel based on the determined velocity. In some embodiments, the user-directed movement comprises a finger of the user moving across and in direct contact with the touch screen.

In some embodiments, the information about the user-directed movement across the touch screen comprises a distance measurement and a time measurement. The distance measurement may comprise a distance between a first position of user-directed contact with the touch screen during the user-directed movement across the touch screen and a second position of user-directed contact with the touch screen during the user-directed movement across the touch screen. The second position may be a last position of user-directed contact with the touch screen during the user-directed movement. The time measurement may comprise an amount of time between the user-directed contact at the first position and the user-directed contact at the second position. The movement intention module 420 may be configured to determine a velocity of the user-directed movement across the touch screen by dividing the distance measurement by the time measurement. In some embodiments, the determination of the intention for movement of visual content of the carousel is further based on the second position of user-directed contact with the touch screen during the user-directed movement across the touch screen.

As previously discussed, in some embodiments, the first position of user-directed contact with the touch screen and the second position of user-directed contact with the screen that are used in the determination of the velocity of the user-directed movement across the touch screen may correspond to the last two detected positions of the user-directed movement (e.g., the last two detected positions of the user's finger contacting the touch screen). This velocity may represent the finger's final velocity as it leaves the touch screen at the end of the user-directed movement across the touch screen.

In some embodiments, the animation determination module 430 is configured to determine a stopping position for the movement of the visual content of the carousel based on the determined intention, and then use a B-spline curve function to determine an animation of the movement of the visual content to the stopping position. In some embodiments, the B-spline curve function is a Bèzier curve function.

In some embodiments, using the B-spline curve function to determine the animation comprises mapping the second position and the stopping position in a Cartesian coordinate system having a position axis and a time axis. The position axis may correspond to positions on the touch screen. A B-spline curve may be interpolated between the second position and the stopping position in the Cartesian coordinate system. The animation determination module 430 may be configured to determine the animation of the movement of the visual content to the stopping position based on the interpolation of the B-spline curve between the second position and the stopping position.

In some embodiments, the display module 410 is further configured to cause the determined animation of the movement of the visual content to be displayed on the touch screen.

It is contemplated that other configurations of the scrolling carousel system 400 and its modules are within the scope of the present disclosure.

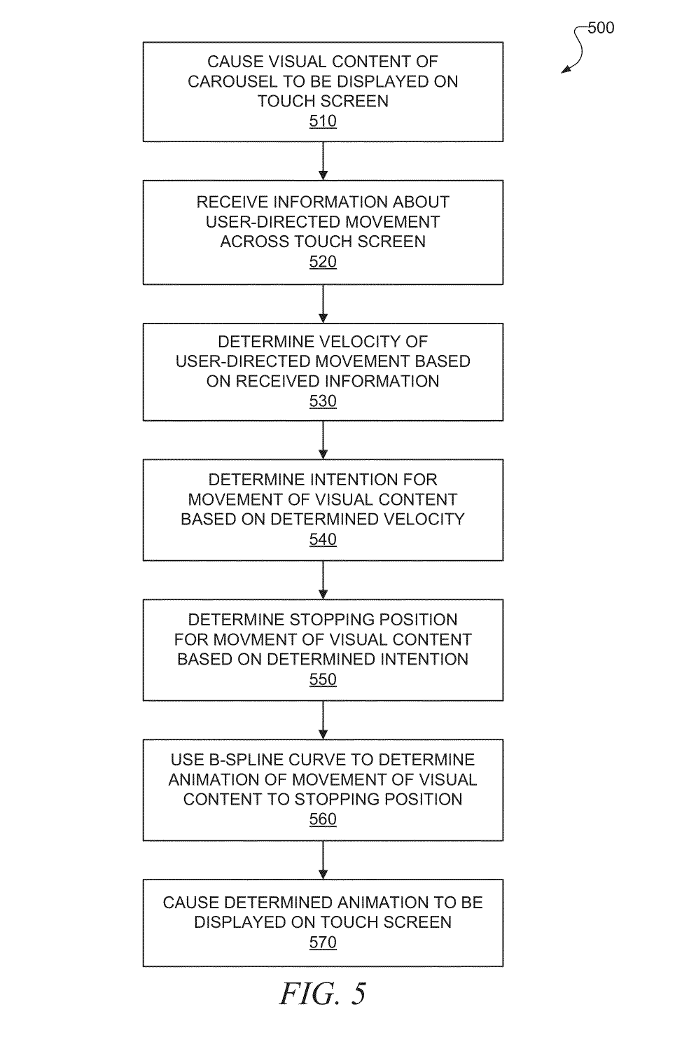

FIG. 5 is a flowchart illustrating a method 500 of providing a scrolling carousel, in accordance with some embodiments. It is contemplated that the operations of method 500 may be performed by a system or modules of a system (e.g., scrolling carousel system 400 in FIG. 4).

At operation 510, visual content of a carousel may be caused to be displayed on a touch screen. The visual content of the carousel may be configured to be scrolled through via user-directed movement across the touch screen. In some embodiments, the touch screen is disposed on a mobile device. In some embodiments, the visual content of the carousel comprises web-based content.

At operation 520, information about a user-directed movement across the touch screen may be received. In some embodiments, the user-directed movement comprises a finger of the user moving across and in direct contact with the touch screen. The information about the user-directed movement across the touch screen may comprise a distance measurement and a time measurement. The distance measurement may comprise a distance between a first position of user-directed contact with the touch screen during the user-directed movement across the touch screen and a second position of user-directed contact with the touch screen during the user-directed movement across the touch screen. The second position may be a last position of user-directed contact with the touch screen during the user-directed movement. The time measurement may comprise an amount of time between the user-directed contact at the first position and the user-directed contact at the second position.

At operation 530, a velocity of the user-directed movement across the touch screen may be determined based on the received information. The velocity of the user-directed movement across the touch screen may be determined by dividing the distance measurement by the time measurement.

At operation 540, an intention for movement of visual content of the carousel may be determined based on the determined velocity. In some embodiments, the determination of the intention for movement of visual content of the carousel may be further based on the second position of user-directed contact with the touch screen during the user-directed movement across the touch screen.

At operation 550, a stopping position for the movement of the visual content of the carousel may be determined based on the determined intention.

At operation 560, a B-spline curve function may be used to determine an animation of the movement of the visual content to the stopping position. In some embodiments, the B-spline curve function is a Bèzier curve function.

At operation 570, the determined animation of the movement of the visual content to the stopping position may be caused to be displayed on the touch screen.

It is contemplated that any of the other features described within the present disclosure may be incorporated into method 500.

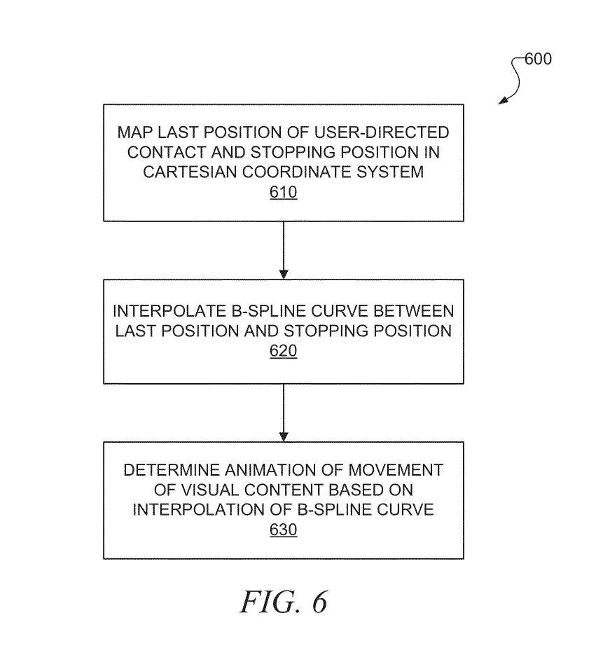

FIG. 6 is a flowchart illustrating a method 600 of using a B-spline curve to determine an animation of movement of visual content on a touch screen, in accordance with some embodiments. It is contemplated that the operations of method 600 may be performed by a system or modules of a system (e.g., scrolling carousel system 400 in FIG. 4).

At operation 610, the last detected position (e.g., the second position discussed above) and the determined stopping position may be mapped in a Cartesian coordinate system having a position axis and a time axis. The position axis may correspond to positions on the touch screen.

At operation 620, a B-spline curve may be interpolated between the second position and the stopping position in the Cartesian coordinate system.

At operation 630, the animation of the movement of the visual content to the stopping position may be determined based on the interpolation of the B-spline curve between the last detected position and the stopping position.

It is contemplated that any of the other features described within the present disclosure may be incorporated into method 500.

In some embodiments, algorithms and equations may be used to make the Bèzier curve, or other B-spline curve, smooth. In some embodiments, in order for the user not to notice the transition to the Bèzier curve, or other B-spline curve, it is important to not move the slide, or other visual content, or to change its velocity. CSS may enforce the former by setting the initial point of a cubic to (0, 0). Regarding the latter, a bezier curve at the origin is tangent to the line between its first two control points. Thus, we just have to ensure that the control point lies on the line where velocity=v (or x/t=v). In some embodiments, the only decision we have with regards to that control point is how far from the origin it should be, which may be a number “i” that can be made up to adjust the user experience. This number “i” may represent how important the user's initial velocity is to the shape of the final curve:

given: x² + t² = i²
given: x / t = v
=> x = sqrt(i² * v²/(1 + v²))

In some embodiments, as we want the animation to finish at the end with 0 velocity, we may put the second intermediate control point with an x coordinate of 1 (the final control point is at (1, 1) by definition), the only other choice we have for the shape of our curve may be how far along the t axis to put the second control point.

In one example, given the velocity (v) and two chosen parameters (importance (0.5) and sameness (chosen to be “t”)), the resulting curve can be expressed using the following function:

function bezier_for_velocity(v) {

var importance = 0.5,

x = (v < 0 ? −1 : 1) * Math.sqrt(importance * importance * (v *
v / (1 + v * v))),
t = x / v,
sameness = t;

return ‘cubic-bezier(‘ + [t, x, sameness, 1.0].join(“, ”) + ’)’;
}
// Control points are (0, 0) (t, x), (sameness, 1), (1, 1)

It is contemplated that other algorithms algorithms and equations may be used to make the Bèzier curve, or other B-spline curve, smooth.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 8 is a block diagram of a machine in the example form of a computer system 800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system comprising:
a machine having a memory and at least one processor;
a display module configured to cause visual content of a carousel to be displayed on a touch screen, the visual content of the carousel comprising a plurality of distinct visual content items and being configured to be scrolled through via user-directed movement across the touch screen;
a movement intention module configured to:
receive information about a user-directed movement across the touch screen,
determine a velocity of the user-directed movement across the touch screen based on the received information, and
determine an intention for movement of visual content of the carousel based on the determined velocity, the determining of the intention comprising determining whether or not the intention is to scroll from a first set of one or more of the visual content items to a second set of one or more of the visual content items, the second set having at least one visual content item not included in the first set; and
an animation determination module configured to:
determine a stopping position for the movement of the visual content of the carousel based on the determined intention, the stopping position being determined to be an original position of the first set of one or more of the visual content items corresponding to a time that that the user-directed movement began in response to a determination of the intention being not to scroll from the first set to the second set, and
use a B-spline curve function to determine an animation of the movement of the visual content to the stopping position, the stopping position being
determined prior to and independently of the determination of the animation of
the movement of the visual content to the stopping position,
the display module being further configured to cause the determined animation of the movement of the visual content to the stopping position to be displayed on the touch screen.

2. The system of claim 1, wherein the B-spline curve function is a Bèzier curve function.

3. The system of claim 1, wherein the user-directed movement comprises a finger of the user moving across and in direct contact with the touch screen.

4. The system of claim 1 wherein the visual content of the carousel comprises web-based content, and the plurality of distinct visual content items comprises a plurality of distinct pages.

5. The system of claim 1, wherein
the information about the user-directed movement across the touch screen comprises a distance measurement and a time measurement, the distance measurement comprising a distance between a first position of user-directed contact with the touch screen during the user-directed movement across the touch screen and a second position of user-directed contact with the touch screen during the user-directed movement across the touch screen, wherein positions of user-directed contact with the touch screen during the user-directed movement are detected, the detected positions comprising a last-detected position and a second-to-last-detected position, the first position being the second-to-last-detected position of user-directed contact, the second position being the last-detected position of user-directed contact, the time measurement comprising an amount of time between the user-directed contact at the first position and the user-directed contact at the second position; and
the movement intention module is configured to determine the velocity of the user-directed movement across the touch screen by dividing the distance measurement by the time measurement.

6. The system of claim 5, wherein using the B-spline curve function to determine the animation comprises:
mapping the second position and the stopping position in a Cartesian coordinate system having a position axis and a time axis, the position axis corresponding to positions on the touch screen;
interpolating a B-spline curve between the second position and the stopping position in the Cartesian coordinate system; and
determining the animation of the movement of the visual content to the stopping position based on the interpolation of the B-spline curve between the second position and the stopping position.

7. The system of claim 5, wherein the determination of the intention for movement of visual content of the carousel is further based on the second position of user-directed contact with the touch screen during the user-directed movement across the touch screen.

8. The system of claim 1, wherein the touch screen is coupled to a mobile device.

9. A method comprising:
causing visual content of a carousel to be displayed on a touch screen, the visual content of the carousel comprising a plurality of distinct visual content items and being configured to be scrolled through via user-directed movement across the touch screen;
receiving information about a user-directed movement across the touch screen;
determining a velocity of the user-directed movement across the touch screen based on the received information;
determining an intention for movement of visual content of the carousel based on the determined velocity, the determining of the intention comprising determining whether or not the intention is to scroll from a first set of one or more of the visual content items to a second set of one or more of the visual content items, the second set having at least one visual content item not included in the first set;
determining a stopping position for the movement of the visual content of the carousel based on the determined intention, the stopping position being determined to be an original position of the first set of one or more of the visual content items corresponding to a time that that the user-directed movement began in response to a determination of the intention being not to scroll from the first set to the second set;
using a B-spline curve function to determine an animation of the movement of visual content to the stopping position, the stopping position being determined prior to and independently of the determination of the animation of the movement of the visual content to the stopping position; and
causing the determined animation of the movement of the visual content to the stopping position to be displayed on the touch screen.

10. The method of claim 9, wherein the B-spline curve function is a Bèzier curve function.

11. The method of claim 9, wherein the user-directed movement comprises a finger of the user moving across and in direct contact with the touch screen.

12. The method of claim 9, wherein the visual content of the carousel comprises web-based content, and the plurality of distinct visual content items comprises a plurality of distinct pages.

13. The method of claim 9, wherein
the information about the user-directed movement across the touch screen comprises a distance measurement and a time measurement, the distance measurement comprising a distance between a first position of user-directed contact with the touch screen during the user-directed movement across the touch screen and a second position of user-directed contact with the touch screen during the user-directed movement across the touch screen, wherein positions of user-directed contact with the touch screen during the user-directed movement are detected, the detected positions comprising a last-detected position and a second-to-last-detected position, the first position being the second-to-last-detected position of user directed contact, the second position being the last-detected position of user-directed contact, the time measurement comprising an amount of time between the user-directed contact at the first position and the user-directed contact at the second position; and
determining a velocity of the user-directed movement across the touch screen comprises dividing the distance measurement by the time measurement.

14. The method of claim 13, wherein using the B-spline curve function to determine the animation comprises:
mapping the second position and the stopping position in a Cartesian coordinate system having a position axis and a time axis, the position axis corresponding to positions on the touch screen;
interpolating a B-spline curve between the second position and the stopping position in the Cartesian coordinate system; and
determining the animation of the movement of the visual content to the stopping position based on the interpolation of the B-spline curve between the second position and the stopping position.

15. The method of claim 13, wherein the determination of the intention for movement of visual content of the carousel is further based on the second position of user-directed contact with the touch screen during the user-directed movement across the touch screen.

16. The method of claim 9, wherein the touch screen is coupled to a mobile device.

17. A non-transitory machine-readable storage medium storing a set of instructions that, when executed by at least one processor, causes the at least one processor to perform operations comprising:
causing visual content of a carousel to be displayed on a touch screen, the visual content of the carousel comprising a plurality of distinct visual content items and being configured to be scrolled through via user-directed movement across the touch screen;
receiving information about a user-directed movement across the touch screen;
determining a velocity of the user-directed movement across the touch screen based on the received information;
determining an intention for movement of visual content of the carousel based on the determined velocity, the determining of the intention comprising determining whether or not the intention is to scroll from a first set of one or more of the visual content items to a second set of one or more of the visual content items, the second set having at least one visual content item not included in the first set;
determining a stopping position for the movement of the visual content of the carousel based on the determined intention, the stopping position being determined to be an original position of the first set of one or more of the visual content items corresponding to a time that that the user-directed movement began in response to a determination of the intention being not to scroll from the first set to the second set;
using a B-spline curve function to determine an animation of the movement of the visual content to the stopping position, the stopping position being determined prior to and independently of the determination of the animation of the movement of the visual content to the stopping position; and
causing the determined animation of the movement of the visual content to the stopping position to be displayed on the touch screen.

18. The non-transitory machine-readable storage medium of claim 17, wherein the B-spline curve function is a Bèzier curve function.

19. The non-transitory machine-readable storage medium of claim 17, wherein the visual content of the carousel comprises web-based content, and the plurality of distinct visual content items comprises a plurality of distinct pages.

20. The non-transitory machine-readable storage medium of claim 17, wherein
the information about the user-directed movement across the touch screen comprises a distance measurement and a time measurement, the distance measurement comprising a distance between a first position of user-directed contact with the touch screen during the user-directed movement across the touch screen and a second position of user-directed contact with the touch screen during the user-directed movement across the touch screen, wherein positions of user-directed contact with the touch screen during the user-directed movement are detected, the detected positions comprising a last-detected position and a second-to-last-detected position, the first position being the second-to-last-detected position of user-directed contact, the second position being the last-detected position of user-directed contact, the time measurement comprising an amount of time between the user-directed contact at the first position and the user-directed contact at the second position; and
using the B-spline curve function to determine the animation comprises:
mapping the second position and the stopping position in a Cartesian coordinate system having a position axis and a time axis, the position axis corresponding to positions on the touch screen;
interpolating a B-spline curve between the second position and the stopping position in the Cartesian coordinate system; and
determining the animation of the movement of the visual content to the stopping position based on the interpolation of the B-spline curve between the second position and the stopping position.
